(19) United States
(12) Patent Application Publication
(10) Pub. No.: US 2014/0066153 A1
(43) Pub. Date: Mar. 6, 2014

(54) WAGERING GAME KIT, SYSTEMS AND METHODS

(71) Applicant: FIVEQ SA, Camorino (CH)

(72) Inventors: Melvin Stanley Williamson, Camorino (CH); Giuseppe Andrea Pappalardo, Camorino (CH); Antonio Scionti, Camorino (CH)

(73) Assignee: FIVEQ SA, Camorino (CH)

(21) Appl. No.: 14/015,852

(22) Filed: Aug. 30, 2013

Related U.S. Application Data
(60) Provisional application No. 61/695,200, filed on Aug. 30, 2012.

(51) Int. Cl. G07F 17/32

(52) U.S. Cl. CPC G07F 17/3288; G07F 17/3293
USPC 463/11; 273/293

(57) ABSTRACT

Systems, methods and a game kit for providing and conducting wagering games involving one or more decks of playing cards with each deck including a first group of cards divided into subgroups of a plurality of cards, a second group of cards that differs from the cards in the first group; and a single card that differs from the cards in the first and second groups.

### CROSS-REFERENCE TO RELATED APPLICATIONS FROM WHICH PRIORITY IS CLAIMED

This application claims the benefit of U.S. Provisional Patent Application No. 61/695,200 filed on Aug. 30, 2012, the disclosure of which is incorporated herein by reference.

### BACKGROUND

1. Field of the Invention

The invention generally relates to new game kits and systems and methods of providing, hosting, conducting and/or facilitating modified wagering games. In particular, the invention relates to a modified playing card systems and methods for providing, hosting, conducting and/or facilitating wagering games using the playing card system, among other things.

2. Description of the Related Art

Many card games have been developed over the years and some are particularly adapted for gambling. Typically, such games include a dealer who deals cards and one or more players who place wagers on whether an outcome will be achieved based on the cards that the dealer deals.

Gaming establishments, including existing casinos or online gaming websites, continually require new games to offer their players. Players are typically attracted to games that provide numerous wagering opportunities, can be played rapidly, and possess relatively decent odds of winning as compared with other casino games. Many of the games that have been successful also offer volatile game play features that further serve to entertain and heighten player interest in such games. Naturally, casino operators seek to provide the most popular games for their gaming patrons.

### SUMMARY OF THE INVENTION

Some embodiments of the invention are directed to systems, methods, and a game kit for providing and conducting wagering games involving one or more decks of playing cards with each deck including a first group of cards divided into subgroups of a plurality of cards, a second group of cards that differs from the cards in the first group; and a single card that differs from the cards in the first and second groups.

Some embodiments of the invention are directed to a game kit, comprising: one or more decks of playing cards with each deck comprising: a first group of cards divided into subgroups of a plurality of cards, wherein each of the subgroups are defined by cards having a single unique visually identifiable characteristic disposed thereon that is not disposed on the cards of any other subgroup; a second group of cards including a single unique visually identifiable characteristic, wherein the same single unique visually identifiable characteristic is associated with all the cards of the second group and differs from the unique visually identifiable characteristics in the first group of cards; a single card which includes a single unique visually identifiable characteristic that differs from the unique identifiable characteristics in the first and second groups; and a physical table with a felt layout disposed thereon including a plurality of player positions, wherein the number of player positions equals the amount of subgroups in the first group of cards and each player position includes one of the unique visually identifiable associated with the subgroups displayed thereon.

In some embodiments, the first group of cards is divided into seven subgroups.

In some embodiments, each subgroup includes the same amount of cards.

In some embodiments, each subgroup includes nine cards.

In some embodiments, the second group includes five cards.

In some embodiments, the unique visually identifiable characteristics for the first group, second group and single card are selected from the group consisting of letters, numbers and symbols.

In some embodiments, the unique visually identifiable characteristics for the first group are playing card rankings of Ace, 2, 3, 4, 5, 6 and 7.

In some embodiments, the single unique visually identifiable characteristic for the second group is a Queen ranked playing card.

Some embodiments of the invention are directed to a method of conducting a wagering game, comprising the steps of: activating a shuffling device to deliver one or more randomly ordered decks of physical playing cards, wherein each deck includes: a first group of cards divided into subgroups of a plurality of cards, wherein each of the subgroups are defined by cards having a single unique visually identifiable characteristic disposed thereon that is not disposed on the cards of any other subgroup; a second group of cards including a single unique visually identifiable characteristic, wherein the same single unique visually identifiable characteristic is associated with all the cards of the second group and differs from the unique visually identifiable characteristics in the first group of cards; a single card which includes a single unique visually identifiable characteristic that differs from the unique identifiable characteristics in the first and second groups; receiving a game wager; dealing cards from the randomly ordered decks of physical playing cards; comparing each card dealt with preset criteria including: a first preset criteria for actuating a first game feature, wherein the first preset criteria is receiving more than one of card from the same subgroup; a second preset criteria for actuating a second game feature, wherein the second preset criteria is a dealing a card from the second group; providing a payout award responsive to the first game feature being actuated; and collecting the game wager and ending the game responsive to the second game feature being actuated.

In some embodiments, the method further includes a third preset criteria for actuating a third game feature, wherein the third preset criteria is dealing the single card. The method may also include providing, presenting and displaying a table layout for play thereon including a plurality of player positions, wherein the number of player positions equals the amount of subgroups in the first group of cards and each player position includes one of the unique visually identifiable associated with the subgroups displayed thereon.

In some embodiments, the unique visually identifiable characteristics for the first group are playing card rankings of Ace, 2, 3, 4, 5, 6 and 7.

In some embodiments, the single unique visually identifiable characteristic for the second group is a Queen ranked playing card.

Some embodiments of the invention are directed to a computer-aided method of providing a wagering game, including a communication device, a processing device and a display device, comprising the steps of: receiving a game wager through a communication device; randomly generating virtual representations of playing cards from one or more decks for display on the display device, wherein each deck comprises: a first group of cards divided into subgroups of a plurality of cards, wherein each of the subgroups are defined by cards having a single unique visually identifiable characteristic disposed thereon that is not disposed on the cards of any other subgroup; a second group of cards including a single unique visually identifiable characteristic, wherein the same single unique visually identifiable characteristic is associated with all the cards of the second group and differs from the unique visually identifiable characteristics in the first group of cards; a single card which includes a single unique visually identifiable characteristic that differs from the unique identifiable characteristics in the first and second groups; comparing each card generated with preset criteria using the processing device, including: a first preset criteria for actuating a first game feature, wherein the first preset criteria is receiving more than one of card from the same subgroup; a second preset criteria for actuating a second game feature, wherein the second preset criteria is a dealing a card from the second group; providing a payout award through the communication device if the first game feature is actuated; and collecting the game wager and ending the game if the second game feature is actuated.

In some embodiments, the computer-aided method may further include the step of displaying a table layout on the display device including a plurality of player positions, wherein the number of player positions equals the amount of subgroups in the first group of cards and each player position includes one of the unique visually identifiable associated with the subgroups displayed thereon.

The communication device may be a data input and/or data output device or a remote computer terminal, such as a home computer or mobile device with access to local or global network. The system and communication device may be configured for providing the modified wagering game to players via an online system or the Internet. The processor may also be remotely located from the display device and communication device.

In some embodiments, the communication device, processor and display device are mounted within a unitary housing. Some embodiments of the invention are directed to a system for providing the methods described above. The aforementioned system may be an electronic gaming machine or electronic platform including multiple data input devices providing player positions.

### BRIEF DESCRIPTION OF THE DRAWINGS

FIG. 1 is a process flow chart depicting an exemplary game play method configured and constructed according to some embodiments of the invention.

FIG. 2 illustrates an exemplary table layout which may be a felt table layout or implemented as a virtual layout on a display or communication device according to some embodiments of the invention.

FIG. 3 is a schematic diagram depicting the components of an exemplary system configured and constructed according to some embodiments of the invention.

### DETAILED DESCRIPTION

The exemplary embodiments herein relate to a game kit including a modified deck of cards for use with wagering games such as the exemplary wagering game described below.

It should be understood that the methods and steps recited herein may be partially or wholly carried out in a variety of ways, such as by a dealer physically using game elements in a casino, via an electronic gaming machine (EGM) in a gaming establishment, through a computer or portable device, such as a mobile phone, capable of communicating via the Internet, global telecommunication network or world wide web, and exemplary embodiments thereof are discussed herein.

In some embodiments, the invention is directed to a game kit including one or more modified decks of playing cards, with each deck being composed of (i) a first group of cards divided into subgroups of cards, with each subgroup including a plurality of cards having a unique visually identifiable characteristic defined thereon such that each subgroup card is associated with a single unique visually identifiable characteristic that differs from the single unique visually identifiable characteristic of the cards of any other subgroup, (ii) a second group of cards with each card having the same single unique identifiable characteristic which is not the same and differs from any of the unique visually identifiable characteristics of the subgroup cards in the first group of cards, and (iii) a single card which includes a single unique visually identifiable characteristic that differs from all of the unique identifiable characteristics in the first and second groups. The game kit further includes a felt table layout having a dealer position and a plurality of player positions defined thereon equal to the amount of subgroups in the first group with each player position including one of the unique visually identifiable characteristics associated with a subgroup disposed thereon.

In some embodiments, the game kit includes a plurality of decks of cards with each deck including: a first group of cards divided into seven subgroups of nine cards each, with each of the nine cards in any subgroup including unique identifiable indicia; a second group including five cards having the same unique identifiable indicia that differs from the first group; and a single card having unique identifiable indicia which differs from the first and second groups. The unique identifiable indicia may include, for example, numbers, pictures, characters, symbols or letters, or combinations thereof. The table layout would include seven player positions with each player position including one of the unique identifiable indicia of the subgroups disposed thereon.

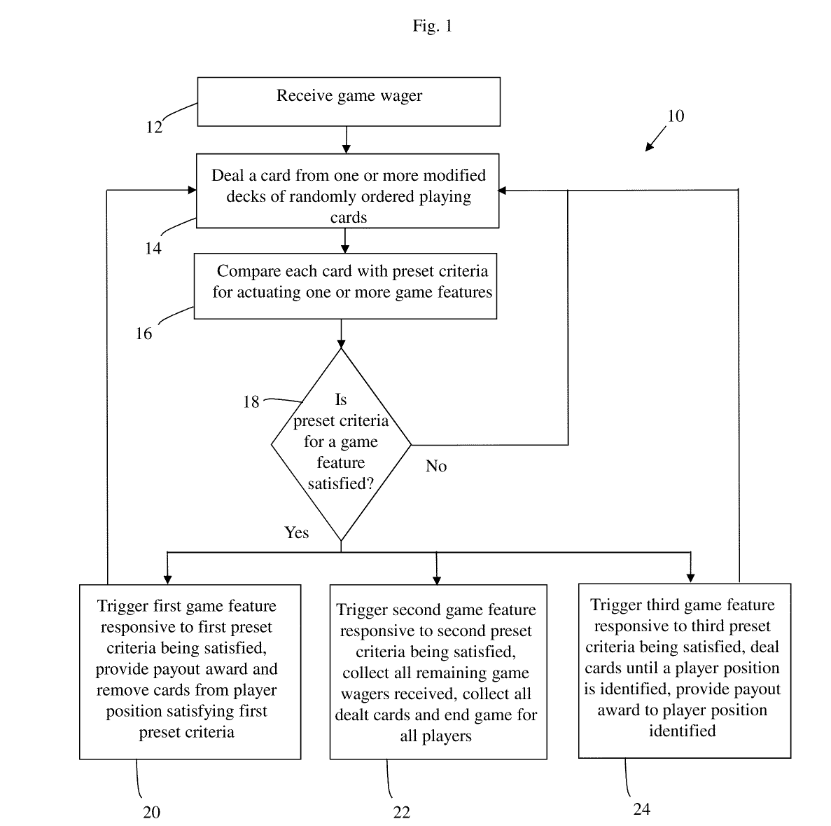

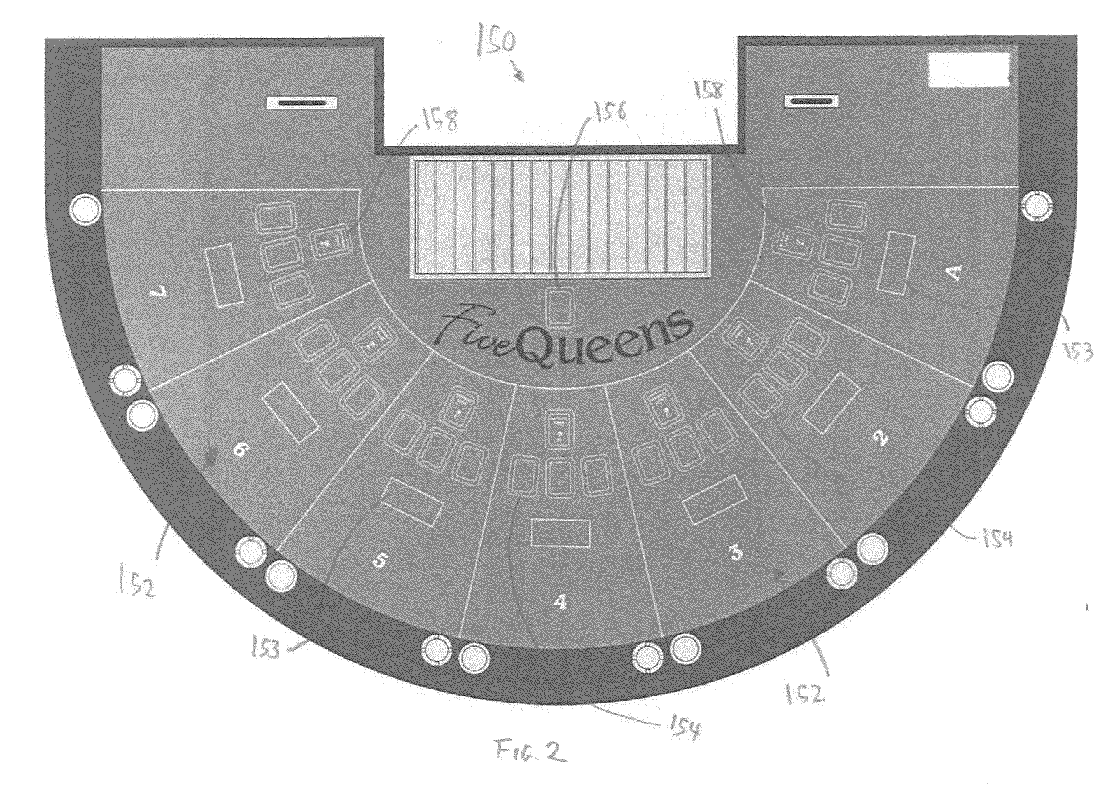

In the exemplary embodiment of a game method 10 is shown in FIG. 1 and discussed herein below, the game kit includes four decks of cards with each game deck including: a first group of cards divided into seven subgroups, the subgroups including nine cards of the following rankings Ace, 2, 3, 4, 5, 6 and 7, respectively; a second group of five Queen ranked cards; and a single card which does not have any of the rankings of the first and second groups and is referred to as the “mystery” card, and the word “mystery” may be printed thereon as the identifiable characteristic for this card. An exemplary table layout 150 shown in FIG. 2 for this embodiment includes seven player positions 152 marked Ace, 2, 3, 4, 5, 6 and 7, respectively.

In step 12, a game wager is received by a player interested in playing the game. It should be understood that receiving a wager typically also involves a player affirmatively engaging in an action that is interpreted to place a monetary amount at risk. By receiving the wager, a gaming operator or host is also placing some monetary amount at risk, which may be determined or expressed as being equal to, or a multiple of, the monetary amount which the player is placing at risk. The affirmative action of the player to place an amount at risk may include pressing a button or physically placing a gaming chip on a designated betting area on a table game felt layout, such as wager area 153 on layout 150. The game operator or host may receive the wager, thus indicating acceptance thereof, through a variety of actions, which may involve illumination of betting areas on a table or other displays, or by continuing to step 14 in which randomly ordered playing cards are distributed to form the initial player hands and the two initial dealer hands as discussed herein.

In step 14, playing cards from the four randomly-ordered game decks, or in other embodiments, randomly generated virtual representations of the game decks, are distributed one card at a time to each player position 152 at designated card areas 154 to form a player hand. An automated shuffling device may be operatively associated with a gaming table for facilitating provision of gaming method 10 which can be operated as part of step 14 in order to provide one or more randomly-ordered game decks. The distributing of cards may follow a particular preset sequence and order. For example, the deal may start with the Ace position and go upwards by number.

As shown in step 16, each card will be compared with one or more preset criterion, which is referred to herein as preset criteria, to determine if a game feature is actuated. The preset criteria may relate to any one or more unique visually identifiable characteristics of the cards as they are dealt or revealed, or the cards at each player position forming a player hand.

In some embodiments, the game features includes a plurality of game features with each game feature being triggered by the satisfaction of an associated preset criteria based on the unique characteristics of the cards as each card is dealt or revealed.

In an exemplary embodiment, the game feature includes one or more of the following game features: a first game feature triggered upon the satisfaction of a first preset criteria, wherein the first preset criteria is dealing more than one card from the same subgroup of cards in the first group; a second game feature triggered if a second preset criteria is satisfied, wherein the second preset criteria is dealing a card from the second group, that is a Queen; and a third game feature is triggered by satisfying a third preset criteria, wherein the third preset criteria is satisfied by dealing a mystery card. Responsive to being triggered, the first game feature includes providing a payout award to the player position with the hand that was dealt the multiple cards from the same subgroup. Responsive to being triggered, the second game feature is an automatic forfeit of the game and game wager by all players. Responsive to being triggered, the third game feature is an award payout to the player position associated with the next card dealt that is not either another mystery card or card from the second group. For example, if a mystery card is dealt, the cards will be dealt until a card from the first group is dealt to identify the player position to receive the payout award. If the next card dealt after a mystery card is from the second group, that is, a Queen, it will not trigger the second preset criteria.

In this embodiment, game method 10 includes all three of the aforementioned game features, and the first preset criteria is the player position receiving three cards from the same subgroup. Thus, as shown in step 18, if one of the three game feature preset criteria is satisfied, then the game feature is actuated, otherwise the deal continues and the method returns to step 14.

If the first game feature is triggered by satisfying the first preset criteria, then as shown by steps 18 and 20 a payout award is provided to the player position having been dealt the card that satisfied the first preset criteria. For example, if the payer position receives three Aces, the first preset criteria is satisfied and the player position will receive an award which may be a multiple of the game wager. In this embodiment, once the first preset criteria is satisfied and payout award is provided the player position is now closed and cards collected. Another player may join by placing a game wager, which may or may not equal the original game wager. The cards which are dealt from the first group are placed in the position 154 of each player position 152 to which they are dealt.

If the second game feature is triggered by satisfying the second preset criteria, then as shown in steps 18 and 22, the game wagers and dealt cards are collected, and the game is ended. Game layout 150 includes a position 156 for the dealer to put any cards from the second group, that is, the Queen cards.

If the third game feature is triggered by satisfying the third preset criteria, then as shown in steps 18 and 24 additional cards are dealt until a card from the first group is dealt to identify the player position to which the payout award should be distributed. The award may be a multiple of the game wager. In this embodiment, the cards dealt after the mystery card do not go to a player position, and the player position remains open for receiving cards in the normal course of dealing. The card from the first group that is used to identify the player position is placed in the position 158 of the corresponding player position 152 on layout 150. Thus, after the payout award is made, the game play continues by returning to step 14.

Game method 10 continues as described until each player position has satisfied the first criteria, and not reentered the game assuming reentry is available, or until a Queen is dealt.

The various illustrative embodiments of the invention may be implemented in conjunction with a physical table as a live table game utilizing physical playing cards and money or chips representative of the actual dollar value of a wager. Alternatively, the game kit and methods according to the invention may be implemented in part or whole by computer hardware devices, and presented by means of computer program code which, by way of example, when executed by a processor, causes the display of the game and conditions of the hands on a display device. A virtual representation of a felt table display such as layout 150 may be presented on a display device, as it should be understood that the methods of the invention would function as described herein whether any one or more of the layout, cards, dealers or wagering chips or apparatus were physically provided or virtually represented and facilitated through a computer with appropriate hardware devices and programs.

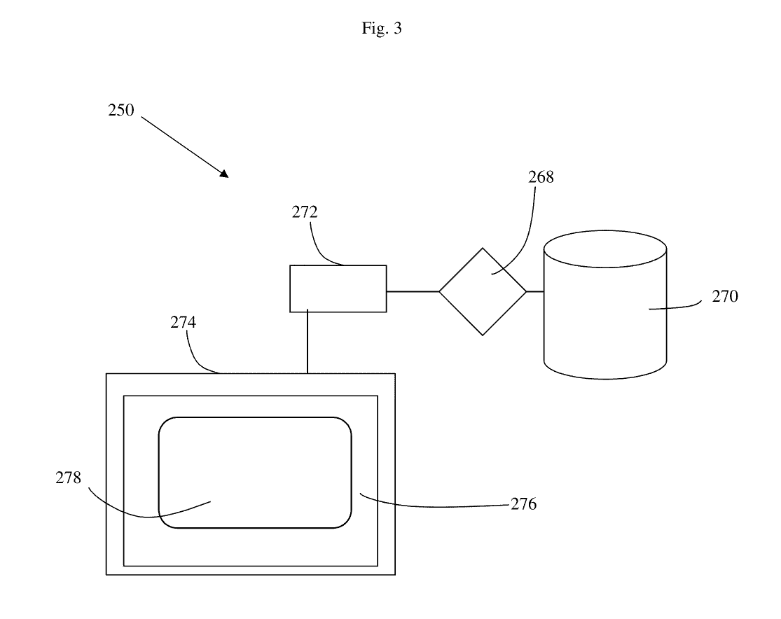

FIG. 3 illustrates an exemplary system 250 constructed in accordance with some embodiments of the invention. System 250 includes processing device 268 in communication with a database or memory device 270, communication or data input/output device 272 and a display device 274. In some embodiments, display device 274 is a touch-enabled device and includes a data input device component. Memory device 270 may include data relating to the underlying game and embodiments of the invention as described herein, such as the preset criteria. A player position 276 is displayed on display device 274 along with virtual representation of a layout, such as layout 150 for transmitting wagers and facilitating play of the methods of the invention, such as method 10. Game play is displayed on display device 274 and processing device 268 facilitates distribution of randomly generated virtual cards. Processing device 268 also compares the dealt cards with the preset criteria. Should any of the preset criteria be satisfied, the associated game feature will be actuated by processing device 268 and indicated on display device 274.

Those skilled in the art will readily appreciate that the methods described herein may be incorporated in systems such as those discussed above that may include various computer and network related software and hardware, such as programs, operating systems, memory storage devices, data input/output devices, data processors, servers with links to data communication systems, wireless or otherwise, and data transceiving terminals, and may be a standalone device or incorporated in another platform, such as a mobile device. The system of the invention may be provided on electronic platforms with multiple player positions. In addition, the system of the invention may be provided at least in part on a personal computing device, such as home computer, laptop or mobile computing device through an online communication connection or connection with the Internet. Those skilled in the art will further appreciate that the precise types of software and hardware used are not vital to the full implementation of the methods of the invention so long as players and operators thereof are provided with useful access thereto or the opportunity to play the game as described herein.

While exemplary systems and methods, and applications of methods of the invention, have been described herein, it should also be understood that the foregoing is only illustrative of a few particular embodiments with exemplary and/or preferred features, as well as principles of the invention, and that various modifications can be made by those skilled in the art without departing from the scope and spirit of the invention. Therefore, the described embodiments should not be considered as limiting of the scope of the invention in any way. Accordingly, the invention embraces alternatives, modifications and variations which fall within the spirit and scope of the invention as set forth in the claims and equivalents thereto.

What is claimed is:

1. A game kit, comprising:
a) one or more decks of playing cards with each deck comprising:
i) a first group of cards divided into subgroups of a plurality of cards, wherein each of the subgroups are defined by cards having a single unique visually identifiable characteristic disposed thereon that is not disposed on the cards of any other subgroup;
ii) a second group of cards including a single unique visually identifiable characteristic, wherein the same single unique visually identifiable characteristic is associated with all the cards of the second group and differs from the unique visually identifiable characteristics in the first group of cards;
iii) a single card which includes a single unique visually identifiable characteristic that differs from the unique identifiable characteristics in the first and second groups; and
b) a physical table with a felt layout disposed thereon including a plurality of player positions, wherein the number of player positions equals the amount of subgroups in the first group of cards and each player position includes one of the unique visually identifiable associated with the subgroups displayed thereon.

2. A game kit as recited in claim 1, wherein the first group of cards is divided into seven subgroups.

3. A game kit as recited in claim 1, wherein each subgroup includes the same amount of cards.

4. A game kit as recited in claim 1, wherein each subgroup includes nine cards.

5. A game kit as recited in claim 1, wherein the second group includes five cards.

6. A game kit as recited in claim 1, wherein the unique visually identifiable characteristics for the first group, second group and single card are selected from the group consisting of letters, numbers and symbols.

7. A game kit as recited in claim 1, wherein the unique visually identifiable characteristics for the first group are playing card rankings of Ace, 2, 3, 4, 5, 6 and 7.

8. A game kit as recited in claim 1, wherein the single unique visually identifiable characteristic for the second group is a Queen ranked playing card.

9. A method of conducting a wagering game, comprising the steps of:
a) activating a shuffling device to deliver one or more randomly ordered decks of physical playing cards, wherein each deck includes:
i) a first group of cards divided into subgroups of a plurality of cards, wherein each of the subgroups are defined by cards having a single unique visually identifiable characteristic disposed thereon that is not disposed on the cards of any other subgroup;
ii) a second group of cards including a single unique visually identifiable characteristic, wherein the same single unique visually identifiable characteristic is associated with all the cards of the second group and differs from the unique visually identifiable characteristics in the first group of cards;
iii) a single card which includes a single unique visually identifiable characteristic that differs from the unique identifiable characteristics in the first and second groups;
b) receiving a game wager;
c) dealing cards from the randomly ordered decks of physical playing cards;
d) comparing each card dealt with preset criteria including:
i) a first preset criteria for actuating a first game feature, wherein the first preset criteria is receiving more than one of card from the same subgroup;
ii) a second preset criteria for actuating a second game feature, wherein the second preset criteria is a dealing a card from the second group;
e) providing a payout award if the first game feature is actuated; and
f) collecting the game wager and ending the game if the second game feature is actuated.

10. A method according to claim 9, further comprising a third preset criteria for actuating a third game feature, wherein the third preset criteria is dealing the single card.

11. A method according to claim 10, further comprising the step of providing a table layout including a plurality of player positions, wherein the number of player positions equals the amount of subgroups in the first group of cards and each player position includes one of the unique visually identifiable associated with the subgroups displayed thereon.

12. A method according to claim 9, wherein the unique visually identifiable characteristics for the first group are playing card rankings of Ace, 2, 3, 4, 5, 6 and 7.

13. A method according to claim 9, wherein the single unique visually identifiable characteristic for the second group is a Queen ranked playing card.

14. A computer-aided method of providing a wagering game, including a communication device, a processing device and a display device, comprising the steps of:
a) receiving a game wager through a communication device;
b) randomly generating virtual representations of playing cards from one or more decks for display on the display device, wherein each deck comprises:
i) a first group of cards divided into subgroups of a plurality of cards, wherein each of the subgroups are defined by cards having a single unique visually identifiable characteristic disposed thereon that is not disposed on the cards of any other subgroup;
ii) a second group of cards including a single unique visually identifiable characteristic, wherein the same single unique visually identifiable characteristic is associated with all the cards of the second group and differs from the unique visually identifiable characteristics in the first group of cards;
iii) a single card which includes a single unique visually identifiable characteristic that differs from the unique identifiable characteristics in the first and second groups;
c) comparing each card generated with preset criteria using the processing device, including:
i) a first preset criteria for actuating a first game feature, wherein the first preset criteria is receiving more than one of card from the same subgroup;
ii) a second preset criteria for actuating a second game feature, wherein the second preset criteria is a dealing a card from the second group;
d) providing a payout award through the communication device if the first game feature is actuated; and
e) collecting the game wager and ending the game if the second game feature is actuated.

15. A computer-aided method according to claim 14, wherein the communication device, processing device and display device are mounted within a unitary housing.

16. A computer-aided method according to claim 14, wherein the processing device is remotely located from the display device and communication device.

17. A computer-aided method according to claim 14, further comprising a third preset criteria for actuating a third game feature, wherein the third preset criteria is dealing the single card.

18. A computer-aided method according to claim 17, further comprising displaying a table layout including a plurality of player positions on the display device, wherein the number of player positions equals the amount of subgroups in the first group of cards and each player position includes one of the unique visually identifiable associated with the subgroups displayed thereon.

19. A computer-aided method according to claim 14, wherein the unique visually identifiable characteristics for the first group are playing card rankings of Ace, 2, 3, 4, 5, 6 and 7.

20. A computer-aided method according to claim 14, wherein the single unique visually identifiable characteristic for the second group is a Queen ranked playing card.
